(19) United States
(12) Patent Application Publication
(10) Pub. No.: US 2020/0016959 A1
(43) Pub. Date: Jan. 16, 2020

(54) FILTER ARRANGEMENT FOR A VEHICLE, INTEGRATED INTO INTERIOR COMPONENT

(71) Applicant: Carl Freudenberg KG, Weinheim (DE)

(72) Inventors: Ulrich Stahl, Laudenbach (DE); Judith Hemmerling, Bretten (DE); Christoph Krambs, Heidelberg (DE); Oliver Kurtz, Rauenberg (DE); Gerhard Schoepping, Weinheim (DE); Birgit Goedicke, Obrigheim (DE); Alen Nosic, Mannheim (DE); Angela Weik, Bruehl (DE); Renate Tapper, Bensheim (DE); Saru Dawar, Court, MI (US); Mark Stiborsky, Weinheim (DE); Anette Arnold, Seeheim-Jugenheim (DE)

(21) Appl. No.: 16/439,771

(22) Filed: Jun. 13, 2019

(30) Foreign Application Priority Data
Jul. 13, 2018 (EP) 18 183 391.4

(51) Int. Cl. B60H 3/06; B01D 46/00; B01D 46/10; B01D 46/52; B01D 46/16; B01D 53/04

(52) U.S. Cl. CPC B60H 3/0608; B01D 46/0036; B01D 46/10; B01D 46/521; B01D 2259/4566; B01D 53/04; B01D 2279/50; B01D 2253/102; B01D 46/16

(57) ABSTRACT

A filter arrangement for a vehicle includes a flat filter element. The filter element has a filter medium and is integrated into an interior component of the vehicle. The filter element forms a surface facing an interior of the vehicle. In an embodiment, air flows through the filter element, and the air exits through the filter element into the interior of the vehicle.

### CROSS-REFERENCE TO PRIOR APPLICATION

Priority is claimed to European Patent Application No. EP 18 183 391.4, filed on Jul. 13, 2018, the entire disclosure of which is hereby incorporated by reference herein.

### FIELD

The invention relates to a filter arrangement for a vehicle, having a flat filter element.

### BACKGROUND

Interior air filters for the filtration of air supplied into a vehicle cabin of a vehicle are known from the prior art. Such a filter, which may have several filtration stages, is described in EP 2 684 591 A1. The filter may be used in the supply air shaft of the vehicle's ventilation or air conditioning system, i.e., at a distance from the vehicle interior.

An alternative approach arises from DE 10 2005 026 556 A1. There, the filters are directly integrated into air ducts of a vehicle's ventilation or air conditioning system.

A disadvantage of the solutions known from the prior art is that, due to the only limited assembly space available, air may be passed into the inside of the vehicle cabin only at certain points. Such a point-source air supply may be felt as a draft by vehicle occupants and thus perceived negatively. Another disadvantage is that, in addition to the point-source air supply into the vehicle cabin, only a point-source air intake of fresh air (also referred to as raw air) takes place—usually in the region of the engine compartment or underbody. The quality of the raw air in these regions is not good, because of contamination by the drive train, tire abrasion, brake dust, etc.

### SUMMARY

In an embodiment, the present invention provides a filter arrangement for a vehicle, comprising: a flat filter element, wherein the filter element has a filter medium and is integrated into interior components of the vehicle, and wherein the filter element forms a surface facing an interior of the vehicle.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 Vehicle with a filter assembly according to the invention of the first embodiment variant

FIG. 2 Vehicle with a filter assembly according to the invention of the second embodiment variant

FIG. 3 A detail of the filter element of the first embodiment variant

FIG. 4 An alternative embodiment of the filter element of the first embodiment variant

FIG. 5 Active and passive filter element in a concept drawing

### DETAILED DESCRIPTION

In an embodiment, an aim of the present invention is to provide a filter arrangement for a vehicle, wherein the air quality in the interior of the vehicle cabin is improved, and with which the air of a vehicle cabin is reliably cleaned. A further aim is to provide a filter arrangement for a vehicle, wherein the air flows uniformly into the vehicle cabin without the air being perceived as a draft.

The filter arrangement according to the invention for the vehicle cabin in a vehicle has a flat filter element. Advantageously, the flat filter element is integrated into the interior components of the vehicle and forms a surface of the vehicle cabin facing the interior of the vehicle. Flat in this context does not necessarily mean even. The flat filter element has an extension, which is larger than the only point-source opening of (conventional) and air outlet streamers and nozzles in vehicle cabins of passenger cars in the range of about 100 cm², and is therefore referred to as flat. In this context, a vehicle is understood to mean a facility with a cabin for transporting at least one person. Thus, a vehicle may be a passenger car, utility vehicle, cabin scooter, ship, train, aircraft, or the like. In contrast to known air filters in vehicles, the filter element does not sit at just any point in the air supply between the air intake and the outflow element, but rather forms a part of a boundary surface of the interior. A covering surface may be provided for the filter element, wherein the covering surface may be formed, for example, by a fabric covering or a non-woven fabric. Restrictions on the color design or the material design of the interior, therefore, do not exist.

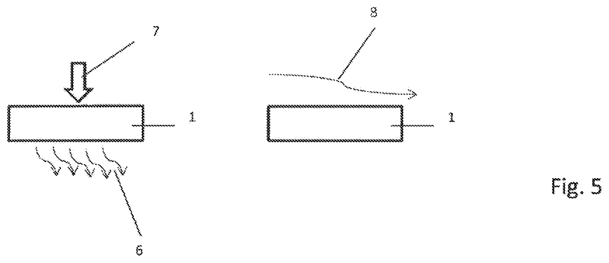

I). In a first embodiment of the filter arrangement according to the invention, air flows through the filter element, i.e., air passes through the structures of the filter element, is filtered in such a way that it is an active filter, and the air enters the interior of the vehicle through the filter element and thus enters the interior of the vehicle as filtered air. An active filtering element is shown roughly schematically in FIG. 5 on the left. Such a filter arrangement has the advantage that low flow velocities can be achieved thanks to the large outflow area of the flat filter element, the air flow entering the vehicle can be distributed uniformly, and the air flow is not perceived as an unpleasant draft. An air curtain or air carpet of purified air may thus be provided in a particularly advantageous manner over the entire surface of the filter element. An air curtain is a region of directed airflow. By advantageous arrangement of the air curtain in the door region, i.e., in the region of a door opening, a shield from the outside air may be generated, and thus the temperature and humidity in the passenger compartment kept stable.

It has been recognized as advantageous for the filter element to be designed in such a way that the filter element has at least one chamber, wherein the chamber may be acted upon by supply air. If several chambers are present, they may be connected to an air passage, separately or with one another. In particular, the chamber may be formed by an at least partially air-permeable air hose—for example, a non-woven hose. This is inexpensive to manufacture and can easily be integrated into interior components of the vehicle.

The filter element of the filter arrangement may also be structured with a fold structure—for example, pleated. Alternatively, the fold structure may be embossed or corrugated. As a result, the surface of the planar filter element is expanded many times, and the filtration performance thus further improved.

In the first embodiment variant of the filter assembly, the interior component of the vehicle may advantageously be an element of the lining of the vehicle cabin, the headliner, a door trim, the dashboard or the instrument panel, a seat—especially, the rear or side surface of the backrest—a headrest, a post paneling, the parcel shelf, the trunk cover, or the trunk lining. The integration of the filter element into the headliner appears to be particularly advantageous, wherein “integration” in this sense also means that the headliner is formed by the filter assembly, since, in this way, all persons in the vehicle cabin of the vehicle may be provided with a uniform air flow, which is not perceived as a draft. A further advantage of this embodiment is that the intake of fresh air may be integrated into the roof regions of the vehicle so that the intake air is less contaminated in comparison with the prior art.

II). In a second embodiment variant of the filter arrangement according to the invention, air flows onto the flat filter element, but does not flow through it, i.e., air flows past the filter element so that it is a passive filter. A passive filter element is shown roughly schematically in FIG. 5 on the right. The filter element may be configured to be easily replaced so that a rapid replacement of the filter element is possible if it no longer fulfills its filtration task.

In a further development of this filter arrangement, the filter element has an adsorptive filter material and may have active carbon, in particular, for this purpose.

The interior component into which the filter arrangement is integrated may be, in particular, the headliner, a foot mat, a door trim, a trunk cover, a surface of a seat, an element of the instrument panel or the dashboard, or a sunblind of the vehicle cabin of the vehicle.

In a particularly advantageous, and therefore preferred, development of this filter element, the filter element is formed as a roller filter. A roller filter is understood to mean a belt filter with filter material, in the form of a belt, which can be removed or wound up from a first roller onto a further roller. If the filter material, which forms an effective surface facing the interior of the vehicle, is “spent” and no longer performs the filtration task, the belt may simply be moved further on the rollers, and thus replaced.

The described invention and the described advantageous developments of the invention in combination with one another, insofar as this is technically sensible, also constitute advantageous developments of the invention.

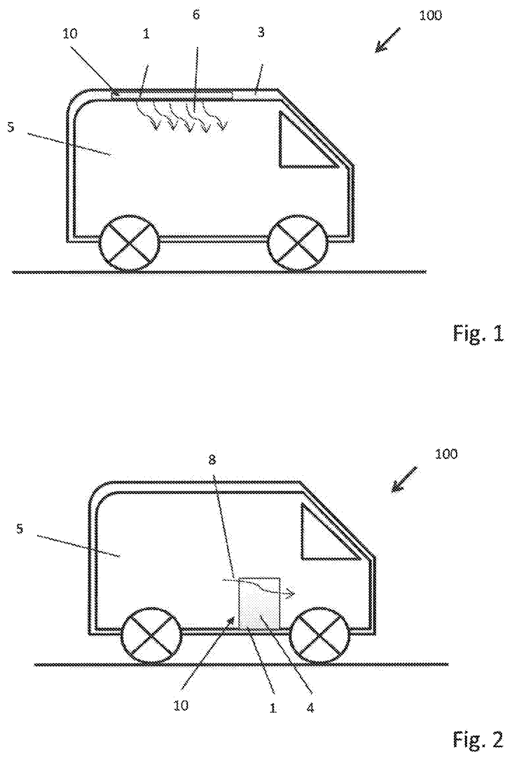

FIG. 1 shows a vehicle 100 having a filter assembly 10 according to the invention in accordance with the first embodiment variant. The filter assembly 10 has a flat filter element 1 acted upon by supply air 7, and is integrated here as an example into the headliner 3 of the vehicle 100. The flat filter element 1 forms, in the region of the headliner 3, a surface facing the interior 5 of the vehicle 100. An air curtain 6 of purified air enters the interior 5 of the vehicle 100 through the flat filter element 1.

FIG. 2 shows a vehicle 100 having a filter arrangement 10 in a second embodiment variant. As passive filter, the filter arrangement 10 has a flat filter element 1 for this purpose. The flat filter element 1 is integrated into a door trim 4 of the vehicle 100. The filter element 1 thus forms a surface facing the interior 5 of the vehicle. In this embodiment, the flat filter element 1 has an adsorptive filter material which has activated carbon fractions. If air 8 flows onto the flat filter element 1, odors and harmful gases can thus be adsorbed thereby. The air quality in the interior 5 of the vehicle 100 can thus be increased.

While FIGS. 1 and 2 show the two embodiment variants of the filter arrangement 10 separately as active or passive filter element 1, a combination of active and passive filter elements 1 in a vehicle 100 is also advantageous.

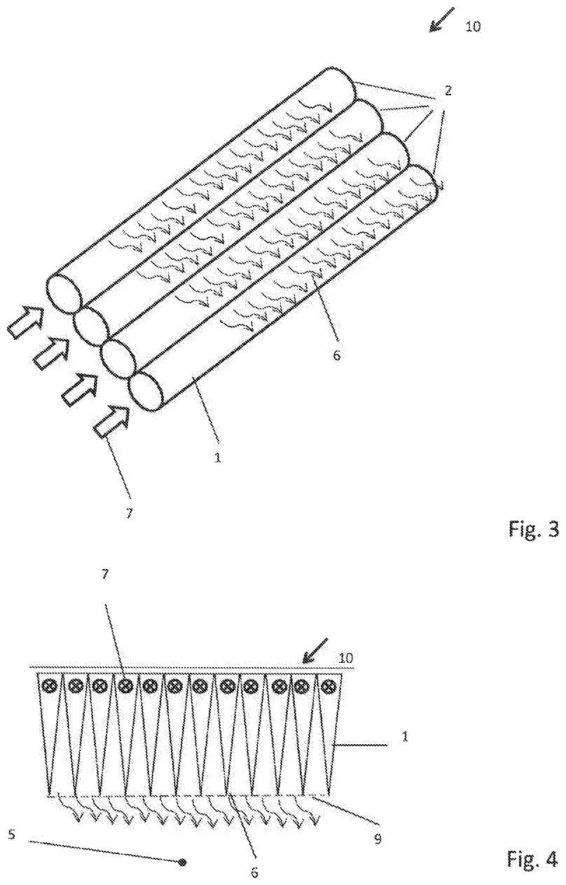

FIG. 3 shows a possible embodiment of an active filter element 1 of a filter arrangement 10. The flat filter element 1 has a plurality of chambers 2, which are designed, for example, as non-woven hoses. A respective chamber 2 is open at one end so that a supply air flow 7 can enter there, and closed at its other end. An air curtain or air carpet 6 of purified air emerges over the surface of the partially air-permeable chambers 2, viz., over the surface facing the vehicle interior. Due to the large outflow area of the filter element 1, at low flow velocity, a large amount of air may be transported into the interior 5 of a vehicle 100 so that all regions of the interior 5 may be supplied with air, and the air curtain 6 is not perceived by occupants of the vehicle 100 as a draft.

FIG. 4 shows a further possible embodiment of an active filter element 1 of a filter arrangement 10. The flat filter element 1 is provided with a folded structure and pleated. A supply air flow 7 is, for example, introduced between the headliner and filter element 1, flows through the filter element 1, and emerges as air curtain 6. Due to the large outflow area of the filter element 1, at low flow velocity, a large amount of air may be transported into the interior 5 of a vehicle 100 so that all regions of the interior 5 may be supplied with air, and the air curtain 6 is not perceived by occupants of the vehicle 100 as a draft. FIG. 4 further indicates a covering surface 9 of the flat filter element 1, which may be formed, for example, by a fabric covering and is designed such that an air curtain 6 may emerge.

As shown in FIG. 1, such filter arrangements 10 may be installed as an active filter in the headliner 3 of a vehicle 100 and integrated therein. Alternatively, integration into other interior components of the vehicle 100 is also conceivable, e.g., into the lining of the vehicle cabin, into the rear of the backrest of seats or into headrests, into the door trim, into the dashboard, into a post paneling, into the parcel shelf, the trunk cover, or the trunk lining.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

1 Flat filter element
2 Chamber (air hose)
3 Headliner
4 Door trim
5 Interior
6 Air curtain or air carpet
7 Supply air flow
8 Incoming air
10 Filter arrangement
100 Vehicle

What is claimed is:

1. A filter arrangement for a vehicle, comprising:
a flat filter element,
wherein the filter element has a filter medium and is integrated into an interior component of the vehicle, and
wherein the filter element forms a surface facing an interior of the vehicle.

2. The filter arrangement according to claim 1, wherein air flows through the filter element, and the air exits through the filter element into the interior of the vehicle.

3. The filter arrangement according to claim 2, wherein the filter element provides an air curtain over its surface.

4. The filter arrangement according to claim 3, wherein the air curtain is arranged in a door region and provides a shield from outside air.

5. The filter arrangement according to claim 1, wherein the filter element has at least one chamber, and
wherein the chamber may be acted upon by supply air.

6. The filter arrangement according to claim 5, wherein the chamber comprises an at least partially air-permeable, non-woven hose.

7. The filter arrangement according to claim 1, wherein the filter medium is structured with a folded structure.

8. The filter arrangement according to claim 1, wherein a non-woven fabric, a solid filter body, or a material bed is used as a material for the filter medium.

9. The filter arrangement according to claim 1, wherein air flows from the interior onto the filter element.

10. The filter arrangement according to claim 9, wherein the filter element has an adsorptive filter material comprising activated carbon.

11. The filter arrangement according to claim 9, wherein the interior components comprises a foot mat or a sunblind.

12. The filter arrangement according to claim 1, wherein the filter element comprises a roller filter.

13. The filter arrangement according to claim 1, wherein the interior components comprises an element of a lining of a vehicle cabin of the vehicle, a headliner, a door trim, a trunk lining, a post paneling, a dashboard, a seat comprising a rear or side surface of a backrest of the seat, a headrest, a parcel shelf, or a trunk cover.
